(19) United States
(12) Patent Application Publication
(10) Pub. No.: US 2013/0345170 A1
(43) Pub. Date: Dec. 26, 2013

(54) Ear Pieces Having an Antimicrobial Treatment

(71) Applicant: Patrick E. Eddy, Allendale, MI (US)

(72) Inventor: Patrick E. Eddy, Allendale, MI (US)

(21) Appl. No.: 13/529,036

(22) Filed: Jun. 21, 2012

(51) Int. Cl. A01N 55/10; H04R 25/00; H04R 1/10; A01P 1/00

(52) U.S. Cl. 514/63; 381/328; 381/380; 381/370

(57) ABSTRACT

A hearing aid, ear bud, ear plug, and hands-free headset are provided that may include one or more surfaces coated with an antimicrobial treatment, which may include a silane quaternary ammonium salt and isopropyl alcohol. The silane quaternary ammonium salt may include an unreacted organofunctional silane to promote bonding to the surfaces of the ear piece, such as 3-(trimethoxysilyl) propyldimethyloctadecyl ammonium chloride. Methods are also provided for coating, or otherwise integrating the antimicrobial treatment on or within a hearing aid, ear bud, ear plug, and hands-free headset.

### BACKGROUND OF THE INVENTION

The present invention generally relates to hearing aids, ear buds, ear plugs, and hands-free headsets of the type typically inserted within the ear canal.

Ear pieces that are inserted within the ear canal are susceptible to bacteria collecting on at least those surfaces of the ear pieces that contact the ear. Such bacteria may cause ear infections or other ailments.

### SUMMARY OF THE INVENTION

According to an embodiment of the present invention, a hearing aid is provided comprising a housing having a plurality of surfaces, wherein at least one of the surfaces is coated with an antimicrobial treatment, and wherein the antimicrobial treatment comprises a silane quaternary ammonium salt.

According to another embodiment of the present invention, an ear bud is provided comprising a housing having a plurality of surfaces, wherein at least one of the surfaces is coated with an antimicrobial treatment, and wherein the antimicrobial treatment comprises a silane quaternary ammonium salt.

According to another embodiment of the present invention, an ear plug is provided comprising a foam substrate configured to at least partially be inserted in an ear canal of a user; and an antimicrobial material incorporated on or within the foam substrate, wherein the antimicrobial material comprises a silane quaternary ammonium salt.

According to another embodiment of the present invention, a hands-free headset is provided comprising a housing having a plurality of surfaces, wherein at least one of the surfaces is coated with an antimicrobial treatment, and wherein the antimicrobial treatment comprises a silane quaternary ammonium salt.

According to another embodiment of the present invention, a method is provided for treating a housing of a hearing aid with an antimicrobial treatment solution comprising the steps of: providing an antimicrobial treatment solution comprising isopropyl alcohol and an antimicrobial treatment substance, wherein the antimicrobial treatment substance comprises a silane quaternary ammonium salt; and applying the antimicrobial treatment solution to at least one surface of the housing of the ear piece.

In one or more of these embodiments, the silane quaternary ammonium salt may have a reacted organofunctional silane to promote bonding to the surfaces of the ear piece housing. The silane quaternary ammonium salt may comprise 3-(trimethoxysilyl) propyldimethyloctadecyl ammonium chloride.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1A is a perspective view of a first hearing aid treated in accordance with an embodiment of the present invention;

FIG. 1B is a perspective view of a second hearing aid treated in accordance with an embodiment of the present invention;

FIG. 1C is a perspective view of ear buds treated in accordance with an embodiment of the present invention;

FIG. 1D is a perspective view of a hands-free headset treated in accordance with an embodiment of the present invention;

FIG. 1E is a perspective view of an ear plug treated in accordance with an embodiment of the present invention;

FIG. 2 is a schematic representation of a monomer that may be used in the embodiments described herein as an antimicrobial treatment substance;

FIG. 3 is a schematic representation of a plurality of the monomers shown in FIG. 2 as applied to a treated surface;

FIG. 4A is a schematic representation of the monomer shown in FIGS. 2 and 3 illustrating a first step in the manner by which the monomer destroys a microbe;

FIG. 4B is a schematic representation of the monomer shown in FIGS. 2 and 3 illustrating a second step in the manner by which the monomer destroys a microbe; and

FIG. 4C is a schematic representation of the monomer shown in FIGS. 2 and 3 illustrating a third step in the manner by which the monomer destroys a microbe.

### DETAILED DESCRIPTION OF PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

Aspects of the present invention generally pertain to an ear piece comprising a housing configured to at least partially be inserted in an ear canal of a user. The housing has a plurality of external surfaces, wherein at least one of the surfaces is coated with an antimicrobial treatment. The antimicrobial treatment may comprise a silane quaternary ammonium salt.

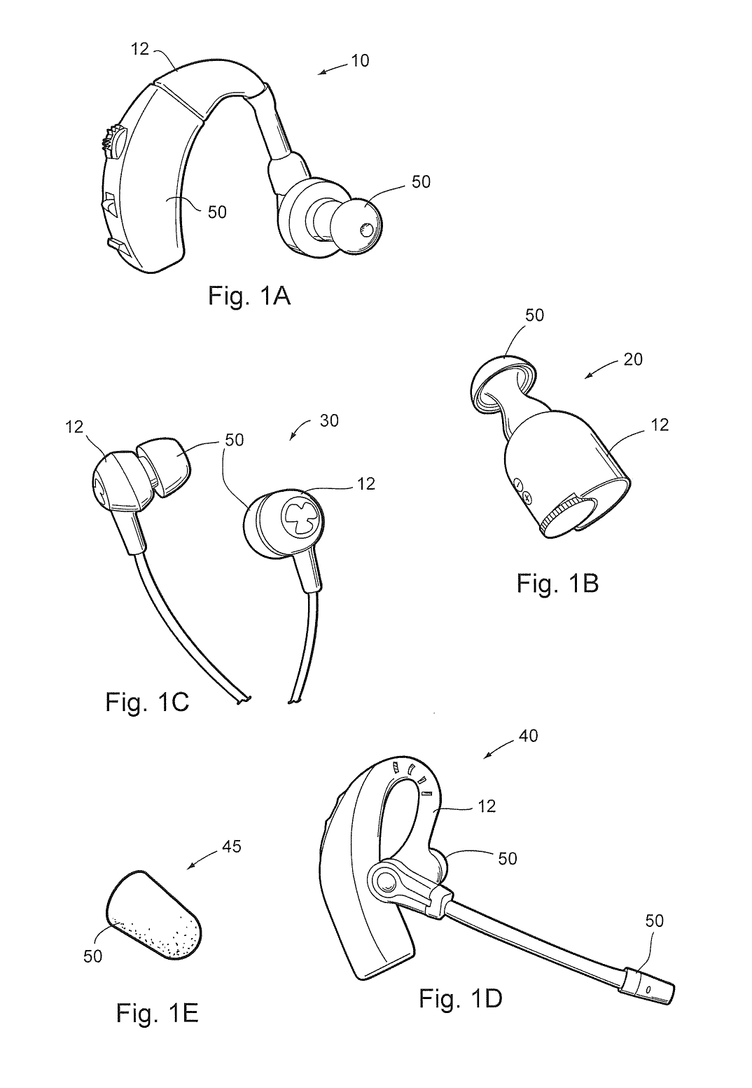

FIG. 1A shows an example of a first embodiment of a hearing aid 10 having a housing 12 that may have one or more of its external surfaces 50 coated with an antimicrobial treatment.

FIG. 1B shows an example of a second embodiment of a hearing aid 20 having a housing 12 that may have one or more of its external surfaces 50 coated with an antimicrobial treatment.

FIG. 1C shows an example of a first embodiment of ear buds 30 having housings 12 that may have one or more of its external surfaces 50 coated with an antimicrobial treatment.

FIG. 1D shows an example of a first embodiment of a hands-free headset 40 having a housing 12 that may have one or more of its external surfaces 50 coated with an antimicrobial treatment.

Ear buds 30 and hands-free headset 40 are of the type used for inserting into the ear canal to listen to audio received from an electronic device such as a cellular telephone, a music player, a computer, or any other electronic device capable of providing an audio signal either directly or by wireless signal.

FIG. 1E shows an example of a first embodiment of a foam ear plug 45 including a foam substrate configured to at least partially be inserted in an ear canal of a user, and an antimicrobial material incorporated on or within the foam substrate such that the antimicrobial material is present at the external surfaces 50 of the foam ear plug.

In general, the antimicrobial treatment may be applied to all surfaces 50 of the above ear pieces (10, 20, 30, 40, 45). However, it is possible to obtain benefits by treating at least one of the surfaces treated with the antimicrobial treatment, and particularly the surfaces contacting the ear canal.

The surfaces 50 of the ear pieces are coated with an antimicrobial treatment that may be sprayed onto the surfaces using a solution and/or may be applied using wipes soaked in such a solution. Suitable wipes and solutions are disclosed in commonly-assigned U.S. patent application Ser. No. 13/182,657, entitled “ANTIMICROBIAL WIPES AND SOLUTION,” filed on Jul. 14, 2011, by Patrick E. Eddy, the entire disclosure of which is incorporated herein by reference.

In a preferred form, the antimicrobial treatment solution contains 30-50 percent isopropyl alcohol and 50-70 percent antimicrobial treatment substance, which is preferably a silane quaternary ammonium salt having an unreacted organofunctional silane. If the antimicrobial treatment solution is applied by spraying, the solution most preferably includes 50 percent isopropyl alcohol and 50 percent of the unreacted antimicrobial treatment substance. If the solution is applied using the wipes, the solution is preferably 30 percent isopropyl alcohol and 70 percent of the unreacted antimicrobial treatment substance.

The preferred silane quaternary ammonium salt includes an active ingredient of 3-(trimethoxysilyl) propyldimethyloctadecyl ammonium chloride and other inert ingredients. The silane quaternary ammonium salt preferably includes about 0.1 to 50 percent of the 3-(trimethoxysilyl) propyldimethyloctadecyl ammonium chloride and most preferably includes about 5 percent of the 3-(trimethoxysilyl) propyldimethyloctadecyl ammonium chloride. Such silane quaternary ammonium salts are available from Aegis Environments, of Midland, Michigan, which is identified as “AEM 5772-5 Antimicrobial,” and from Piedmont Chemical Industries I, LLC of High Point, N.C., which is identified as “PROMOFRESH X 105.” The antimicrobial treatment solution with the isopropyl alcohol is available from MicrobeCare, LLC of Allendale, Michigan, under the trademark MICROBECARE™.

The isopropyl alcohol may have a concentration of 70-90 percent. By providing the unreacted organofunctional silane in isopropyl alcohol, the organofunctional silane does not react with the wipe substrates or the inside of the wipe container such that it is free to later react and permanently covalently bond with the surfaces 50 of the ear piece. Isopropyl alcohol is preferred as it evaporates quickly once the solution is wiped onto the treated surface to allow the unreacted organofunctional silane to more quickly react with the treated surface.

The above described silane quaternary ammonium salt is preferred because it is an organofunctional silane antimicrobial treatment substance that is substantially free from arsenic, silver, tin, heavy metals and polychlorinated phenols; copper; or a silver-ion emitter. In addition, it not only eliminates bacteria on contact, but it remains on the treated surfaces 50 and kills any bacteria subsequently contacting these surfaces. Such treatment preferably lasts at least one week, more preferably several months, and most preferably indefinitely.

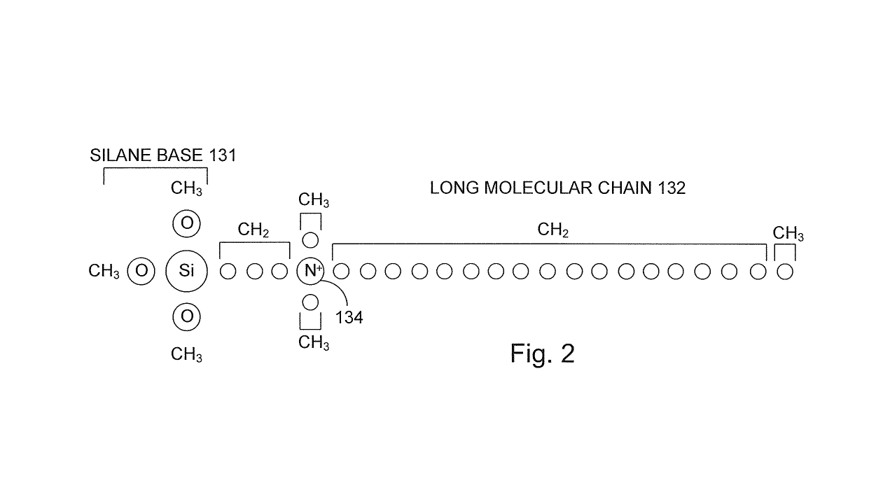

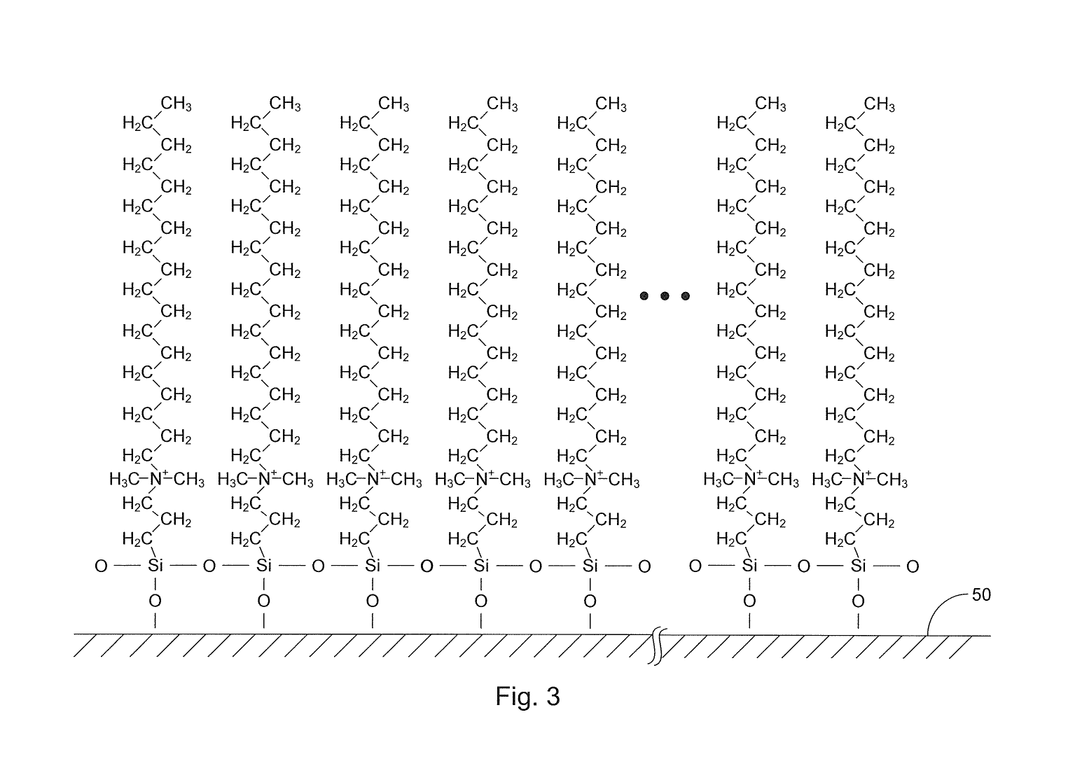

FIG. 2 shows a schematic representation of a monomer form 130 of a preferred organofunctional silane serving as the antimicrobial treatment substance. As illustrated, monomer 130 includes a silane base 131 for bonding to a surface 50, a positively charged nitrogen molecule 134, and a long molecular chain 132. As shown in FIG. 3, the silane bases of these monomers covalently and permanently bond to each other and to the surface 50 to be treated in such a way that the long molecular chains are aligned and pointing outward from the surface 50. This tight bonding provides a micropolymer network that serves as a protective coating on the outside of the surface 50 that destroys any microbes that come into contact.

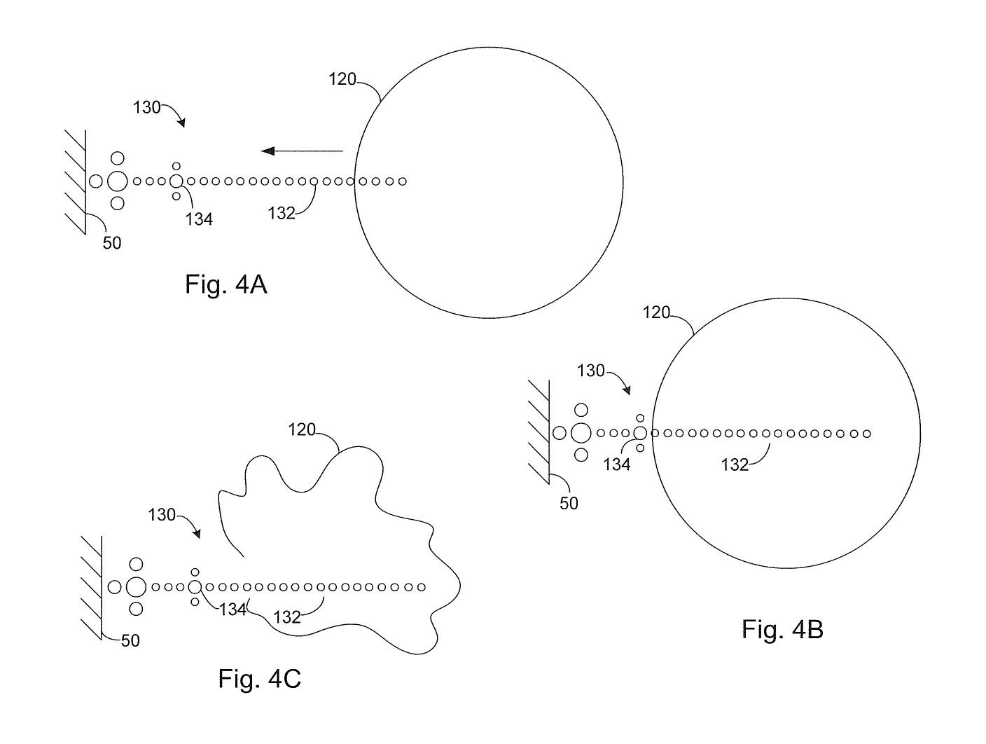

The manner by which the preferred organofunctional silane destroys microbes is illustrated in FIGS. 4A-4C. Such microbes may include bacteria, mold, mildew, algae, etc. As shown in FIG. 4A, the cell membrane 120 of the microbe is attracted to the treated surface 50 of the ear piece and then is punctured by the long molecular chain 132 of the monomer 130. As the microbe is drawn closer because of the positive-negative ion exchange, the monomer 130 penetrates further into the cell membrane 120 as shown in FIG. 4B. Once the cell membrane 120 is penetrated deeply, it is physically ruptured by a sword-like action and then electrocuted by a positively charged nitrogen molecule 134 of the monomer 130, thus destroying the microbe as illustrated in FIG. 4C. Thus, the microbes are eliminated without “using up” any of the antimicrobial active ingredients, which remain on the surfaces 50 ready to continue protecting the treated item against further microbial contamination.

The preferred organofunctional silane also prevents odor, staining and product deterioration that may be associated with microbe contamination. The preferred organofunctional silane is also beneficial because it permanently bonds to a treated surface, covers a broad spectrum of activity with no negative effects or drawbacks, and is easily incorporated and easily verifiable.

The preferred organofunctional silane is designed to react and create a covalent bond with the surfaces 50 of the ear piece. The reacted substance is held onto those surfaces 50 until the covalent bond is broken. Tests have shown that most industrial cleaners or disinfectants will not remove the preferred antimicrobial treatment substance. The method of removal is by abrasion. In the event that the ear piece or at least a part of the ear piece is made of foam or silicone, the antimicrobial material may be integrally formed within the foam or silicone. In general, foams and silicones are formed of slurries processed at relatively low temperatures. These low temperatures allow the antimicrobial material to be mixed in with the slurry and therefore integrated within the resulting foam or silicone part. Thus, for example, a foam ear plug may be made with a foam substrate configured to at least partially be inserted in an ear canal of a user, and an antimicrobial treatment incorporated on or within the foam substrate. The percentage of antimicrobial material in the slurry may vary from 0.001% to 20%.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

1. A hearing aid comprising:
a housing configured to at least partially be inserted in an ear canal of a user, said housing having a plurality of external surfaces, wherein at least one of said surfaces is coated with an antimicrobial treatment,
wherein said antimicrobial treatment comprises a silane quaternary ammonium salt.

2. The hearing aid of claim 1, wherein said silane quaternary ammonium salt includes a reacted organofunctional silane to promote bonding to the surfaces of the housing.

3. The hearing aid of claim 1, wherein said silane quaternary ammonium salt comprises 3-(trimethoxysilyl) propyldimethyloctadecyl ammonium chloride.

4. The hearing aid of claim 1, wherein said antimicrobial treatment comprises an antimicrobial treatment solution comprising said silane quaternary ammonium salt and isopropyl alcohol.

5. The hearing aid of claim 4, wherein the antimicrobial treatment solution comprises about 30 percent to about 50 percent of isopropyl alcohol.

6. The hearing aid of claim 4, wherein the antimicrobial treatment solution comprises about 50 percent to about 70 percent of the antimicrobial treatment substance.

7. The hearing aid of claim 1, wherein said antimicrobial treatment is substantially free from arsenic, silver, tin, heavy metals and polychlorinated phenols.

8. The hearing aid of claim 1, wherein the antimicrobial treatment is covalently bonded to the at least one of said surfaces and is capable of emitting ions that aid in the destruction of a microbe.

9. An ear bud comprising:
a housing configured to at least partially be inserted in an ear canal of a user, said housing having a plurality of external surfaces, wherein at least one of said surfaces is coated with an antimicrobial treatment,
wherein said antimicrobial treatment comprises a silane quaternary ammonium salt.

10. The ear bud of claim 9, wherein said silane quaternary ammonium salt includes a reacted organofunctional silane to promote bonding to the surfaces of the housing.

11. The ear bud of claim 9, wherein said silane quaternary ammonium salt comprises 3-(trimethoxysilyl) propyldimethyloctadecyl ammonium chloride.

12. The ear bud of claim 9, wherein said antimicrobial treatment comprises an antimicrobial treatment solution comprising said silane quaternary ammonium salt and isopropyl alcohol.

13. The ear bud of claim 12, wherein the antimicrobial treatment solution comprises about 30 percent to about 50 percent of isopropyl alcohol.

14. The ear bud of claim 12, wherein the antimicrobial treatment solution comprises about 50 percent to about 70 percent of the antimicrobial treatment substance.

15. A hands-free headset comprising:
a housing configured to at least partially be inserted in an ear canal of a user, said housing having a plurality of external surfaces, wherein at least one of said surfaces is coated with an antimicrobial treatment,
wherein said antimicrobial treatment comprises a silane quaternary ammonium salt.

16. The hands-free headset of claim 15, wherein said silane quaternary ammonium salt includes a reacted organofunctional silane to promote bonding to the surfaces of the housing.

17. The hands-free headset of claim 15, wherein said silane quaternary ammonium salt comprises 3-(trimethoxysilyl) propyldimethyloctadecyl ammonium chloride.

18. The hands-free headset of claim 15, wherein said antimicrobial treatment comprises an antimicrobial treatment solution comprising said silane quaternary ammonium salt and isopropyl alcohol.

19. The hands-free headset of claim 18, wherein the antimicrobial treatment solution comprises about 30 percent to about 50 percent of isopropyl alcohol.

20. The hands-free headset of claim 18, wherein the antimicrobial treatment solution comprises about 50 percent to about 70 percent of the antimicrobial treatment substance.

21-25. (canceled)

26. An ear plug comprising:
a foam substrate configured to at least partially be inserted in an ear canal of a user; and
an antimicrobial material incorporated on or within said foam substrate,
wherein said antimicrobial material comprises a silane quaternary ammonium salt.

27. The ear plug of claim 26, wherein said silane quaternary ammonium salt includes a reacted organofunctional silane.

28. The ear plug of claim 26, wherein said silane quaternary ammonium salt comprises 3-(trimethoxysilyl) propyldimethyloctadecyl ammonium chloride.

29-33. (canceled)

34. An ear piece comprising:
a housing configured to at least partially be inserted in an ear canal of a user, said housing having a plurality of external surfaces, wherein at least one of said surfaces is coated with an antimicrobial treatment,
wherein said antimicrobial treatment comprises a silane quaternary ammonium salt.

35. The ear piece of claim 34, wherein said silane quaternary ammonium salt includes a reacted organofunctional silane to promote bonding to the surfaces of the housing.

36. The ear piece of claim 35, wherein said silane quaternary ammonium salt comprises 3-(trimethoxysilyl) propyldimethyloctadecyl ammonium chloride.

37. The ear piece of claim 34, wherein said antimicrobial treatment comprises an antimicrobial treatment solution comprising said silane quaternary ammonium salt and isopropyl alcohol.

38. The ear piece of claim 34, wherein said ear piece is a hearing aid.

39. The ear piece of claim 34, wherein said ear piece is an ear bud.

40. The ear piece of claim 34, wherein said ear piece is a hands-free headset.

41. The ear piece of claim 34, wherein said ear piece is an ear plug.
